(19) United States
(12) Patent Application Publication
(10) Pub. No.: US 2009/0168626 A1
(43) Pub. Date: Jul. 2, 2009

(54) OPTICAL PICKUP DEVICE AND PHOTODETECTOR

(76) Inventors: Hiroaki YAMAMOTO, Hyogo (JP); Naoto Shimada, Hyogo (JP); Naoki Nakanishi, Shiga (JP); Takuya Okuda, Kyoto (JP); Yasufumi Shirakawa, Osaka (JP)

Correspondence Address: MCDERMOTT WILL & EMERY LLP, 600 13TH STREET, NW, WASHINGTON, DC, 20005-3096, US

(21) Appl. No.: 12/236,048

(22) Filed: Sep. 23, 2008

(30) Foreign Application Priority Data
Dec. 27, 2007 (JP) 2007-337349

(51) Int. Cl. G11B 7/00

(52) U.S. Cl. 369/100; G9B/7

(57) ABSTRACT

An optical pickup device includes: a first light-receiving element for receiving a main beam of a first light beam; second and third light-receiving elements for receiving sub-beams of the first light beam; a fourth light-receiving element for receiving a main beam of a second light beam; and fifth and sixth light-receiving elements for receiving sub-beams of the second light beam. The first through third light-receiving elements are located on a first line with the first light-receiving element sandwiched between the second and third light-receiving elements. The fourth through sixth light-receiving elements are located on a second line with the fourth light-receiving element sandwiched between the fifth and sixth light-receiving elements. The first line and the second line are parallel to each other.

### CROSS-REFERENCE TO RELATED APPLICATION

The disclosure of Japanese Patent Application No. 2007-337349 filed in Japan on Dec. 27, 2007 including specification, drawings and claims is incorporated herein by reference in its entirety.

### BACKGROUND OF THE INVENTION

(1) Field of the Invention

The present invention relates to optical pickup devices and photodetectors for use in optical information processors for processing such as recording of information on optical information recording media and reproducing or erasing of information recorded on optical information recording media.

(2) Background Art

Information recorded on an optical information recording medium (optical disk) such as a compact disc (CD) or a digital versatile disc (DVD) is read out by focusing a light beam emitted from a light source, such as a semiconductor laser, on a recording track of the optical disk with an objective lens and then converting light reflected off the optical disk into an electrical signal with a photodetector. To accurately focus a light beam on a desired recording track of an optical disk rotating at high speed, a focus error signal and a tracking error signal are detected to control the position of an objective lens in consideration of, for example, runout and decentration of the optical disk.

A differential push-pull (DPP) method is known as a typical method for detecting a tracking error signal. In the DPP method, a light beam is separated into three beams of a main beam, a +1st order diffracted beam, and a −1st order diffracted beam. These three beams converge on three adjacent guide grooves provided at a given pitch on an optical disk. Push-pull signals obtained by detecting reflected light of the beams and performing an arithmetic operation thereon show a phase difference of 180° between the main beam and the +1st and −1st order diffracted beams. Thus, by performing arithmetic processing on these push-pull signals, only offset components included in the push-pull signals are selectively canceled by each other so that a good tracking error signal is detected. In view of this, the DPP method is widely employed especially for DVD recording optical pickups (see, for example, Japanese Examined Patent Publication No. 4-34212).

Currently-used optical disks have various standards, and the pitch of guide grooves varies depending on the standards of the optical disks. For example, the guide groove pitch of disks such as a write-once DVD-R (Recordable) and an erasable DVD-RW (Disk ReWritable) is 0.74 μm, whereas the guide groove pitch of disks such as an erasable DVD-RAM (Random Access Memory) is 1.23 μm. In this situation, an optical pickup capable of recording and reproducing information on two or more types of such optical disks conforming to different standards is demanded. To meet this demand, an optical pickup device is proposed as follows: (see, for example, Japanese Laid-Open Patent Publication No. 2004-145915).

In the optical pickup device disclosed in the above-mentioned publication, a special diffraction grating for separating a light beam is partitioned into three areas and the phase of a periodic grating groove structure in an area is successively shifted from that in an adjacent area by 90°. A tracking error detection method using such a special diffraction grating, called an in-line DPP method, allows stable tracking error detection to be performed on a plurality of optical information recording media having different guide groove pitches.

### SUMMARY OF THE INVENTION

A conventional optical pickup device employing the foregoing conventional in-line DPP method, however, has the following problems.

FIG. 12 illustrates convergence spots formed by focusing light beams on an optical information recording medium with a conventional optical pickup device. A convergence spot 101 associated with a +1st order diffracted beam exhibits a higher intensity on the right of the radial direction X of the optical information recording medium and a lower intensity on the left. On the other hand, a convergence spot 102 associated with a −1st order diffracted beam exhibits a lower intensity on the right and a higher intensity on the left. This can be explained as follows:

As illustrated in FIG. 13, a special diffraction grating used in a conventional in-line DPP method has a structure in which the phase of grating grooves 119a in a region 119 is 90° ahead of that of grating grooves 120a in a middle region 120 and the phase of grating grooves 121a in a region 121 is 90° behind that of the grating grooves 120a. Accordingly, the phase of a +1st order diffracted beam which has passed through the region 119 is 90° ahead of that of a +1st order diffracted beam which has passed through the middle region 120 and the phase of a +1st order diffracted beam which has passed through the region 121 is 90° behind that of the +1st order diffracted beam which has passed through the middle region 120. On the other hand, for −1st order diffracted beams, the relationship between the phase of the grating grooves and the diffracted beams is reversed. In other words, the phase of a −1st order diffracted beam which has passed through the region 119 is 90° behind that of a −1st order diffracted beam which has passed through the middle region 120 and the phase of a −1st order diffracted beam which has passed through the region 121 is 90° ahead of that of the −1st order diffracted beam which has passed through the middle region 120.

As a result, the +1st order diffracted beam has a higher intensity in the region 121 where the phase is retarded so that the convergence spot 101 associated with the +1st order diffracted beam on the optical information recording medium exhibits a higher intensity on the right and a lower intensity on the left. In contrast, the −1st order diffracted beam has a higher intensity in the region 119 where the phase is retarded so that the convergence spot 102 associated with the −1st order diffracted beam exhibits a lower intensity on the right and a higher intensity on the left.

FIG. 14 shows signal waveforms of DPP signals obtained by the convergence spots as described above. In FIG. 14, the ordinate indicates the signal intensity and the abscissa indicates the relative position of convergence spots on an optical information recording medium. Reference sign MPP denotes a push-pull signal of a main beam corresponding to a 0th order diffracted beam, reference sign SPP1 denotes a push-pull signal of a preceding sub-beam corresponding to a +1st order diffracted beam, reference sign SPP2 denotes a push-pull signal of a succeeding sub-beam corresponding to a −1st order diffracted beam, and reference sign DPP denotes a tracking error signal obtained from the signals MPP, SPP1, and SPP2, as expressed by the following Equation (1):

DPP=MPP−k×(SPP1+SPP2) (1)

where k is an arbitrary amplification factor. Since intensity distributions of the convergence spots associated with the +1st order diffracted beam and the −1st order diffracted beam show left-right asymmetries, the phases of SPP1 and SPP2 deviate from 180° with respect to that of MPP. Accordingly, when a signal intensity difference occurs between SPP1 and SPP2, DPP deviates from an appropriate value so that the convergence spots cannot be formed on an identical guide groove. As a result, no stable tracking error signal detection can be achieved with an in-line DPP method. In FIG. 14, appropriate values of SPP1, SPP2, and DPP are indicated by broken lines.

To solve this problem, the phases of SPP1 and SPP2 are matched by rotating diffraction gratings. However, in such a case, an optical pickup having light sources with two wavelengths for recording and reproducing information on information recording media of both a DVD and a CD has a complicated optical configuration in which optical axes are matched with a prism using different light sources and diffraction gratings. This is because a DVD and a CD need different optimum rotation angles of diffraction gratings. Thus, it has been impossible to fabricate an optical system at low cost using a monolithic two-wavelength semiconductor laser in which two light sources are closely located.

It is therefore an object of the present invention to implement an optical pickup device having light sources with two wavelengths for performing stable tracking error detection on a plurality of optical information recording media with different guide groove pitches, while maintaining advantages of an in-line DPP method.

To achieve the object, an optical pickup device according to the present invention includes a photodetector having a first light-receiving element group and a second light-receiving element group.

Specifically, an optical pickup device according to the present invention is an optical pickup device for recording information on an optical information recording medium and for reading and erasing information recorded on the optical information recording medium and includes: a first light source for emitting a first light beam with a wavelength of λ1; a second light source for emitting a second light beam with a wavelength of λ2; a diffraction grating for separating each of the first light beam and the second light beam into at least a main beam and two sub-beams; and a photodetector for receiving the first and second light beams reflected off a recording face of an optical information recording medium.

The diffraction grating is divided into first, second, third, and fourth regions having periodic structures with different phases by division lines extending in parallel with a tangential direction of a track on the optical information recording medium. The second region and the third region are located between the first region and the fourth region in such a manner that the second region is closer to the first region. The periodic structure in the first region has a phase different from that in the second region. The periodic structure in the second region has a phase substantially 180° different from that in the third region. The periodic structure in the first region has a phase substantially 180° different from that in the fourth region.

The photodetector includes: a first light-receiving element group for receiving the first light beam; and a second light-receiving element group for receiving the second light beam. The first light-receiving element group includes: a first light-receiving element for receiving the main beam obtained from the first light beam by the diffraction grating; a second light-receiving element for receiving one of the two sub-beams obtained from the first light beam by the diffraction grating; and a third light-receiving element for receiving the other sub-beam obtained from the first light beam by the diffraction grating. The second light-receiving element group includes: a fourth light-receiving element for receiving the main beam obtained from the second light beam by the diffraction grating; a fifth light-receiving element for receiving one of the two sub-beams obtained from the second light beam by the diffraction grating; and a sixth light-receiving element for receiving the other sub-beam obtained from the second light beam by the diffraction grating. Each of the first through sixth light-receiving elements is divided into at least two light-receiving regions by a division line extending along a tangential direction of the optical information recording medium. The first, second, and third light-receiving elements are located on a first line with the first light-receiving element sandwiched between the second and third light-receiving elements. The fourth, fifth, and sixth light-receiving elements are located on a second line with the fourth light-receiving element sandwiched between the fifth and sixth light-receiving elements. The first line and the second line are parallel to each other.

The optical pickup device of the present invention does not need to have a complicated optical configuration in which different light sources and diffraction gratings are used to match optical axes with a prism. This enables fabrication of an optical system at low cost using a monolithic two-wavelength semiconductor laser in which two light sources are closely located.

### BRIEF DESCRIPTION OF THE DRAWINGS

FIG. 1 is a block diagram illustrating an optical pickup device according to an embodiment of the present invention.

FIG. 2 is a circuit diagram illustrating a photodetector of the optical pickup device.

FIG. 3 is a plan view illustrating a diffraction grating of the optical pickup device.

FIG. 4 is a plan view illustrating the shapes of convergence spots formed on a recording face of an optical information recording medium by the optical pickup device.

FIG. 5 is a graph showing waveforms of signals obtained by the optical pickup device.

FIG. 6 is a plan view showing an example of a relationship between a diffraction grating of the optical pickup device and the centers of light beams.

FIG. 7 is a plan view illustrating a modified example of the diffraction grating of the optical pickup device.

FIG. 8 is a plan view illustrating another modified example of the diffraction grating of the optical pickup device.

FIG. 9 is a plan view illustrating still another modified example of the diffraction grating of the optical pickup device.

FIG. 10 shows the amounts of change in DPP signal amplitude with a shift of an objective lens of the optical pickup device.

FIG. 11 shows a relationship between the percentage of change in DPP signal amplitude and the amount of phase difference between the first region and the second region of the diffraction grating of the optical pickup device.

FIG. 12 is a plan view illustrating the shapes of convergence spots formed on a recording face of an optical information recording medium by a conventional optical pickup device.

FIG. 13 is a plan view illustrating a diffraction grating of a conventional optical pickup device.

FIG. 14 is a graph showing waveforms of signals obtained by a conventional optical pickup device.

### DETAILED DESCRIPTION OF THE INVENTION

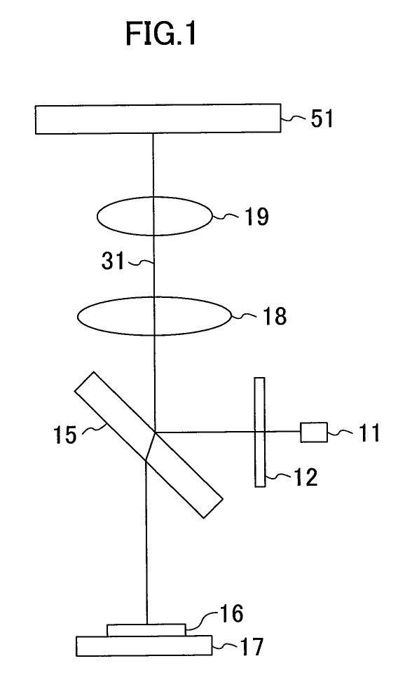

An embodiment of the present invention will be described with reference to the drawings. FIG. 1 schematically illustrates a configuration of an optical pickup device according to an embodiment of the present invention.

As illustrated in FIG. 1, the optical pickup device of this embodiment includes a light source 11, such as a monolithic two-wavelength semiconductor laser, for emitting a light beam 31 with a wavelength λ1 and a light beam 32 with a wavelength λ2 for recording information on an optical information recording medium 51 and reproducing information recorded on the optical information recording medium 51. The optical pickup device further includes: a diffraction grating 12 for diffracting and separating the light beam 31 into at least a main beam 31a (not shown) of a 0th order diffracted beam, a sub-beam 31b (not shown) of a +1st order diffracted beam, and a sub-beam 31c (not shown) of a −1st order diffracted beam and for diffracting and separating the light beam 32 into at least a main beam 32a (not shown) of a 0th order diffracted beam, a sub-beam 32b (not shown) of a +1st order diffracted beam, and a sub-beam 32c (not shown) of a −1st order diffracted beam; a half mirror 15 for guiding the separated light beams 31 and 32 to the optical information recording medium 51; and an integrated circuit board 17 provided with a photodetector 16 for receiving the light beams 31 and 32 reflected from the optical information recording medium 51.

A collimating lens 18 and an objective lens 19 are placed between the half mirror 15 and the optical information recording medium 51. The light beams 31 and 32 emitted from the light source 11 are diffracted and separated into at least three light beams of a 0th order diffracted beam, a +1st order diffracted beam, and a −1st order diffracted beam by the diffraction grating 12, are reflected off the half mirror 15, and then reach the objective lens 19 through the collimating lens 18. The 0th order diffracted beam, the +1st order diffracted beam, and the −1st order diffracted beam obtained by the diffraction grating 12 converge on a recording face of the optical information recording medium 51 by the objective lens 19 to respectively form three convergence spots.

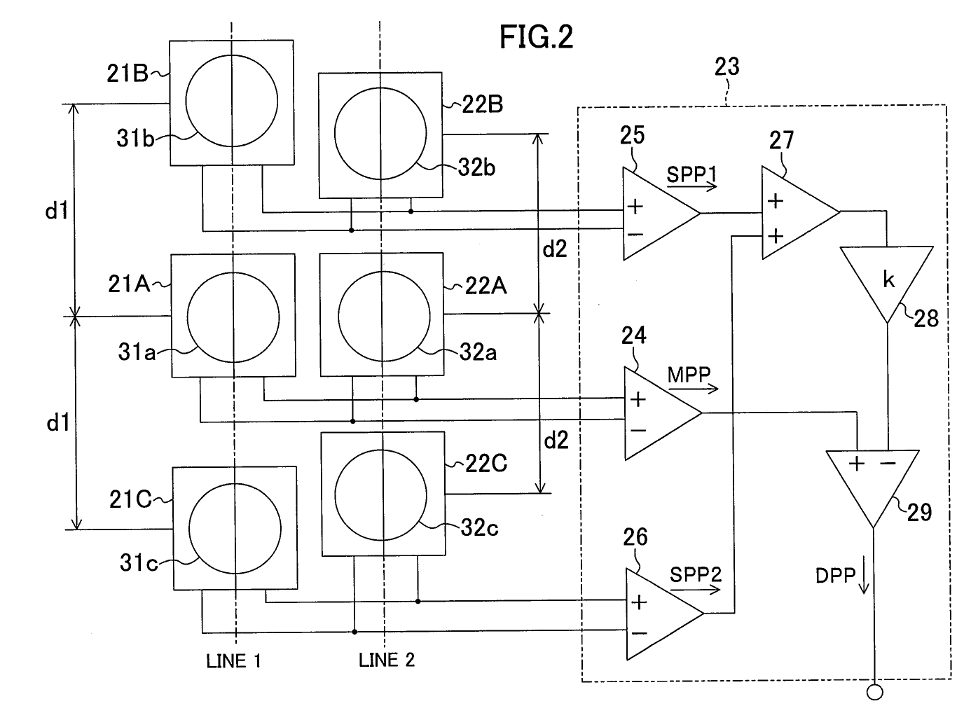

FIG. 2 illustrates a circuit configuration of the integrated circuit board 17 provided with the photodetector 16 in the optical pickup device shown in FIG. 1. As illustrated in FIG. 2, the integrated circuit board 17 includes: a first light-receiving element group (i.e., a light-receiving element 21A, a light-receiving element 21B, and a light-receiving element 21C) for receiving the light beam 31; a second light-receiving element group (i.e., a light-receiving element 22A, a light-receiving element 22B, and a light-receiving element 22C) for receiving the light beam 32; and an arithmetic processing circuit 23 for performing arithmetic operation on signals from the light-receiving elements.

Each of the light-receiving elements 21A, 21B, 21C, 22A, 22B, and 22C is divided into at least two light-receiving regions by a division line.

The light-receiving element 21B, the light-receiving element 21A, and the light-receiving element 21C of the first light-receiving element group are arranged in this order on a line 1 with a distance d1 kept from one another. The light-receiving element 22B, the light-receiving element 22A, and the light-receiving element 22C of the second light-receiving element group are arranged in this order on a line 2 with a distance d2 kept from one another. The lines 1 and 2 on which the two light-receiving element groups are respectively provided are parallel to each other. The distances d1 and d2 between the light-receiving elements satisfy the following Equation (2) with respect to the wavelengths λ1 and λ2 of the light beams:

d1/d2=λ1/λ2 (2)

This enables the inventive optical pickup device to diffract a light beam 31 and a light beam 32 using one diffraction grating 12, whereas a conventional optical pickup with two-wavelength light sources needs to use diffraction gratings with different rotation angles.

In the light-receiving elements with the configuration described above, the main beam 31a and the two sub-beams 31b and 31c obtained from the light beam 31 by the diffraction grating 12 are received by the light-receiving element 21A, the light-receiving element 21B, and the light-receiving element 21C, respectively, and the main beam 32a and the two sub-beams 32b and 32c obtained from the light beam 32 by the diffraction grating 12 are received by the light-receiving element 22A, the light-receiving element 22B, and the light-receiving element 22C, respectively.

Signals detected by the light-receiving element 21A, the light-receiving element 21B, the light-receiving element 21C, the light-receiving element 22A, the light-receiving element 22B, and the light-receiving element 22C are input to the arithmetic processing circuit 23. Before the input, the signals from the light-receiving elements 21A and 22A have been added together, the signals from the light-receiving elements 21B and 22B have been added together, and the signals from the light-receiving elements 21C and 22C have been added together, by connecting lines. These additions are not necessary, and the signals to be added may be switched depending on the type of the optical information recording medium 51 which is being used. The operation may be performed by individual operating circuits independently of each other.

The arithmetic processing circuit 23 includes: subtractors 24, 25, and 26 for receiving signals from the light-receiving elements 21A and 22A, signals from the light-receiving elements 21B and 22B, and signals from the light-receiving elements 21C and 22C, respectively; and an adder 27, an amplifier 28, and a subtractor 29 for receiving signals from the subtractors 24, 25, and 26. Upon receiving the signals from the light-receiving elements 21A, 21B, and 21C, the subtractors 24, 25, and 26 output push-pull signals MPP, SPP1, and SPP2, respectively. The adder 27, the amplifier 28, and the subtractor 29 in the arithmetic processing circuit 23 will be specifically described later.

Although FIG. 2 shows a circuit configuration in which each light-receiving element is divided into two light-receiving regions, each light-receiving element may be divided into three or more light-receiving regions. For example, each light-receiving element may be divided into four by two orthogonal division lines to obtain a focus error signal with astigmatism. Description herein is focused on detection of a tracking error signal using two-divided light-receiving elements for simplicity.

FIG. 2 schematically shows a beam for each light-receiving element in the shape of a circle. However, the shapes of beams are not limited to this. In the case of employing astigmatism for a focus error signal, the beam on each light-receiving element is rotated substantially 90°. Accordingly, in this case, each light-receiving element needs to be rotated 90° beforehand.

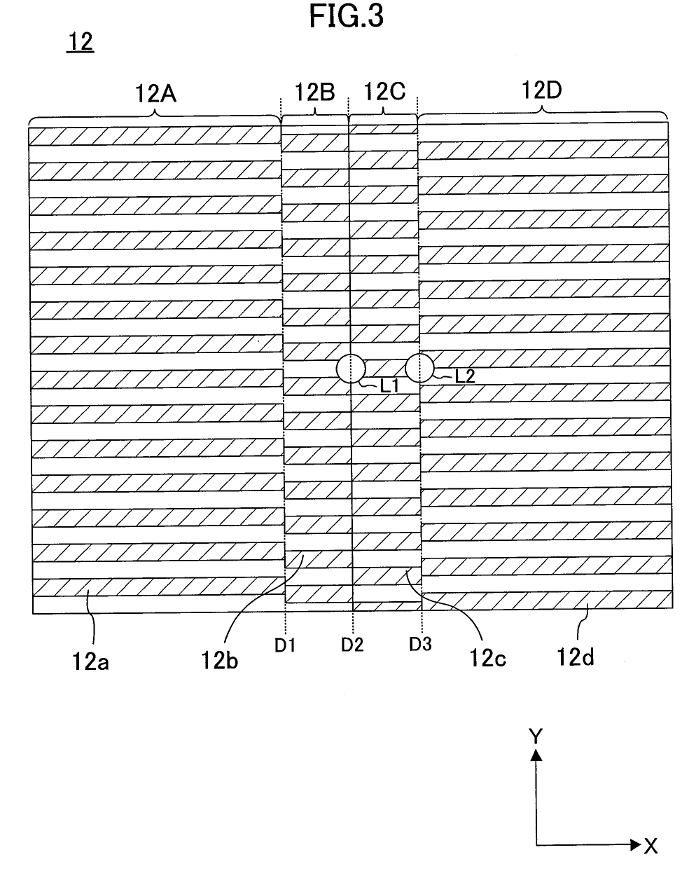

A feature of the optical pickup device of this embodiment is the diffraction grating 12 for diffracting the light beams 31 and 32, and is especially a periodic structure thereof. FIG. 3 illustrates the periodic structure, i.e., a grating pattern, of the diffraction grating 12.

As illustrated in FIG. 3, the grating plane of the diffraction grating 12 is divided into four regions of first, second, third, and fourth regions 12A, 12B, 12C, and 12D by division lines D1, D2, D3 extending in a direction (hereinafter, referred as a Y direction) in which guide grooves of the optical information recording medium 51 extend, i.e., substantially in parallel with a tangential direction of tracks on the optical information recording medium 51. The term “parallel” in this case means a parallel direction in consideration of an optical system provided between the diffraction grating 12 and the optical information recording medium 51. The first region 12A and the second region 12B are adjacent to each other with the division line D1 sandwiched therebetween, the second region 12B and the third region 12C are adjacent to each other with the division line D2 sandwiched therebetween, and the third region 12C and the fourth region 12D are adjacent to each other with the division line D3 sandwiched therebetween.

As illustrated in FIG. 3, in the first, second, third, and fourth regions 12A, 12B, 12C, and 12D, grating grooves 12a, 12b, 12c, and 12d, respectively, are periodically provided along the radial direction (hereinafter, referred to as an X direction) of the optical information recording medium 51. In this embodiment, the widths of the grating grooves 12a, 12b, 12c, and 12d and the widths of portions (i.e., projecting portions) between these grading grooves are set equal to each other.

The phase of the periodic structure formed by the grating grooves 12a in the first region 12A is substantially 90° ahead of (+90° shifts from) that formed by the grating grooves 12b in the second region 12B. In other words, the period of arranging the grating grooves 12a in the first region 12A shifts by ¼ from that of arranging the grating grooves 12b in the second region 12B in the +Y direction. The phase of the periodic structure in the fourth region 12D is substantially 90° behind (−90° shifts from) that in the second region 12B. In other words, the period of arranging the grating grooves 12d in the fourth region 12D shifts by ¼ from that of arranging the grating grooves 12b in the second region 12B in the −Y direction. Accordingly, the phase of the periodic structure in the first region 12A is substantially 180° different from that in the fourth region 12D. The phase of the periodic structure in the third region 12C substantially 180° shifts from that in the second region 12B. In other words, the period of arranging the grating grooves 12c in the third region 12C shifts by ½ from that of arranging the grating grooves 12b in the second region 12B in the +Y direction.

The phase difference in periodic structure between the regions does not need to be precisely 90° or 180°. It is sufficient that the convergence spots on the recording face of the optical information recording medium 51 have a shape as described below. Thus, the difference may include an error of about ±10°.

Now, the case of the light beam 31 will be described. In this embodiment, as illustrated in FIG. 3, the center (emission center) L1 of the light beam 31 emitted from the light source 11 is located on the division line D2 within the assembly precision range of the device.

The light beam 31 which has entered the diffraction grating 12 is separated into sub-beams having given phase differences with the periodic structures in the first, second, third, and fourth regions 12A, 12B, 12C, and 12D, and the obtained sub-beams are guided to the optical information recording medium 51.

Now, it will be described why the optical pickup device of this embodiment is capable of performing stable tracking error detection on optical information recording media having different periods of guide grooves.

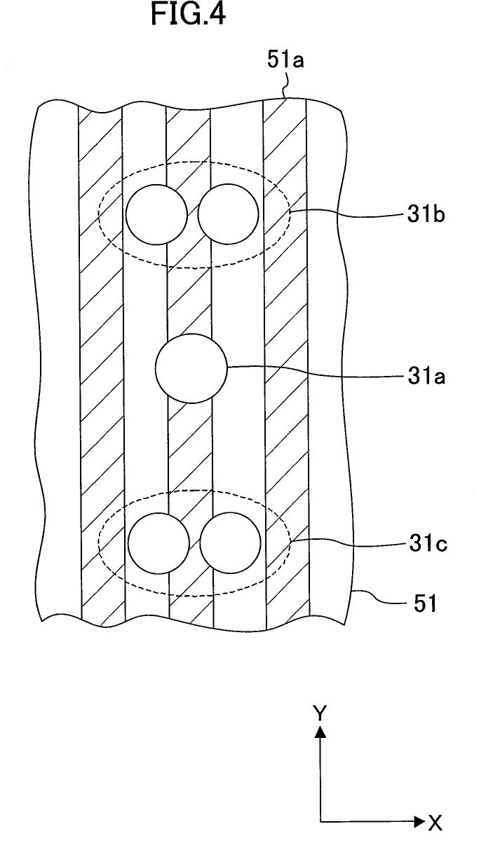

FIG. 4 illustrates the shapes of convergence spots of the main beam 31a and the two sub-beams 31b and 31c obtained from the optical beam by the diffraction grating 12 on the recording face of the optical information recording medium 51. In FIG. 4, the X direction also indicates the radial direction of the optical information recording medium and the Y direction also indicates the direction along which guide grooves extend.

The phases in the second region 12B and the third region 12C of the diffraction grating 12 are 180° different from each other. Thus, diffracted light which has passed through the second region 12B and diffracted light which has passed through the third region 12C cancel each other, resulting in that the convergence spot of each of the sub-beams 31b and 31c on the recording face of the optical information recording medium 51 shows a lower intensity at its center. In this case, it is sufficient to reduce the intensity at the center of the convergence spot of each of the sub-beams 31b and 31c. The phase difference between the second region 12B and the third region 12C may include an error of about ±10° with respect to 180°. Even with such an error, no disadvantages will occur.

The phase of the diffraction grating in the first region 12A is 90° ahead of that in the second region 12B and the phase of the diffraction grating in the fourth region 12D is 90° ahead of that in the third region 12C. Accordingly, the phase of a +1st order diffracted beam which has passed through the first region 12A is 90° ahead of that of a +1st order diffracted beam which has passed through the second region 12B and the phase of a +1st order diffracted beam which has passed through the fourth region 12D is 90° ahead of that of a +1st order diffracted beam which has passed through the third region 12C. In contrast, the phases of −1st order diffracted beams are 90° behind. Accordingly, left-right asymmetry of spot shapes, which is observed in a conventional in-line DPP method, does not occur, and the intensity distribution shows left-right symmetry about the axis extending along the Y direction. In this case, each of the phase differences between the first region 12A and the second region 12B and between the fourth region 12D and the third region 12C may include an error of about ±10° with respect to 90°. Even with such an error, no disadvantages will occur.

As illustrated in FIG. 4, a plurality of guide grooves 51a are periodically arranged on the recording face of the optical information recording medium 51. FIG. 4 also shows that convergence spots on which the main beam 31a, the sub-beam 31b, and the sub-beam 31c obtained from the light beam 31 are focused by the objective lens 19 are located on one of the guide grooves 51a.

The main beam 31a, the sub-beam 31b, and the sub-beam 31c are reflected off the respective convergence spots, and these reflected beams are received by the light-receiving element 21A, the light-receiving element 21B, and the light-receiving element 21C, respectively, of the photodetector 16. The light-receiving element 21A, the light-receiving element 21B, and the light-receiving element 21C output a push-pull signal MPP associated with the main beam 31a, a push-pull signal SPP1 associated with the sub-beam 31b, and a push-pull signal SPP2 associated with the sub-beam 31c, respectively.

Offset components of the signals MPP, SPP1, and SPP2 resulting from a radial shift (i.e., a shift along the radial direction of the optical information recording medium) of the objective lens 19 and from inclination of the optical information recording medium 51 occur on the same side (i.e., the same phase) with respect to each of the radial shift of the objective lens 19 and the inclination of the optical information recording medium 51. Accordingly, a differential push-pull (DPP) signal which has canceled offsets resulting from the radial shift of the objective lens 19 and the inclination of the optical information recording medium 51 is detected using the adder 27, the amplifier 28, and the subtractor 29 as shown in FIG. 2, by the following Equation (3):

DPP=MPP−k×(SPP1+SPP2) (3)

where k is the amplification factor of the amplifier 28.

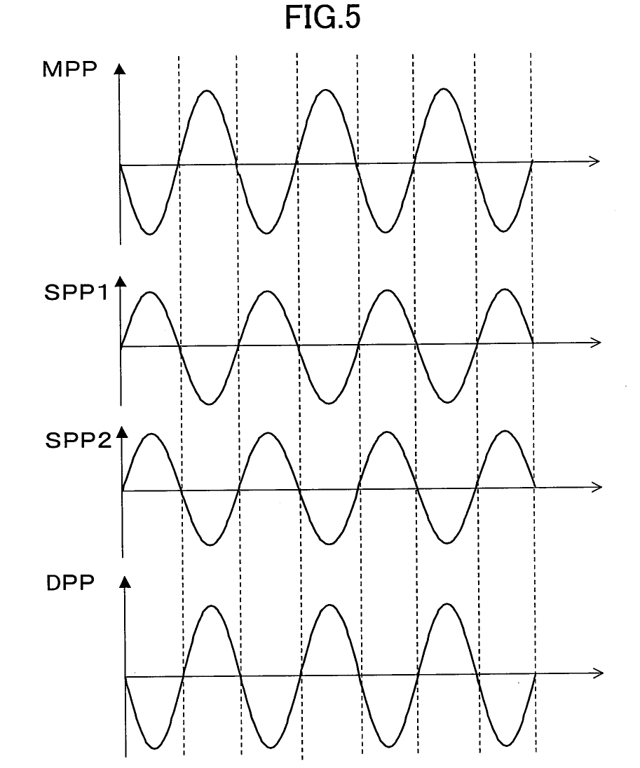

FIG. 5 shows output waveforms of a push-pull signal MPP, a push-pull signal SPP1, a push-pull signal SPP2, and a DPP signal obtained based on Equation (3). In FIG. 5, the ordinate indicates the signal intensity and the abscissa indicates the relative position of convergence spots on the optical information recording medium 51. As shown in FIG. 5, the phases of SPP1 and SPP2 precisely 180° shift from that of MPP. Accordingly, even when a signal intensity difference occurs between SPP1 and SPP2, the DPP signal obtained based on Equation (3) has an appropriate value, thereby allowing convergence spots to be formed on an identical guide groove.

As illustrated in FIG. 2, the input of the adder 27 is connected to the outputs of the subtractor 25 and the subtractor 26, and the input of the amplifier 28 is connected to the output of the adder 27. The input of the subtractor 29 is connected to the outputs of the subtractor 24 and the amplifier 28. This configuration allows operation expressed as Equation (3) to be performed. The coefficient k in Equation (3) is used for correcting differences in light intensity among the main beam 31a, the sub-beam 31b, and the sub-beam 31c reflected off the optical information recording medium 51. If the ratio among the main beam 31a, the sub-beam 31b, and the sub-beam 31c is a:b:b, the coefficient k needs to be a/2b. That is, the coefficient k is a constant determined depending on the type of the optical information recording medium 51. The signal processing circuit may have a conventional configuration.

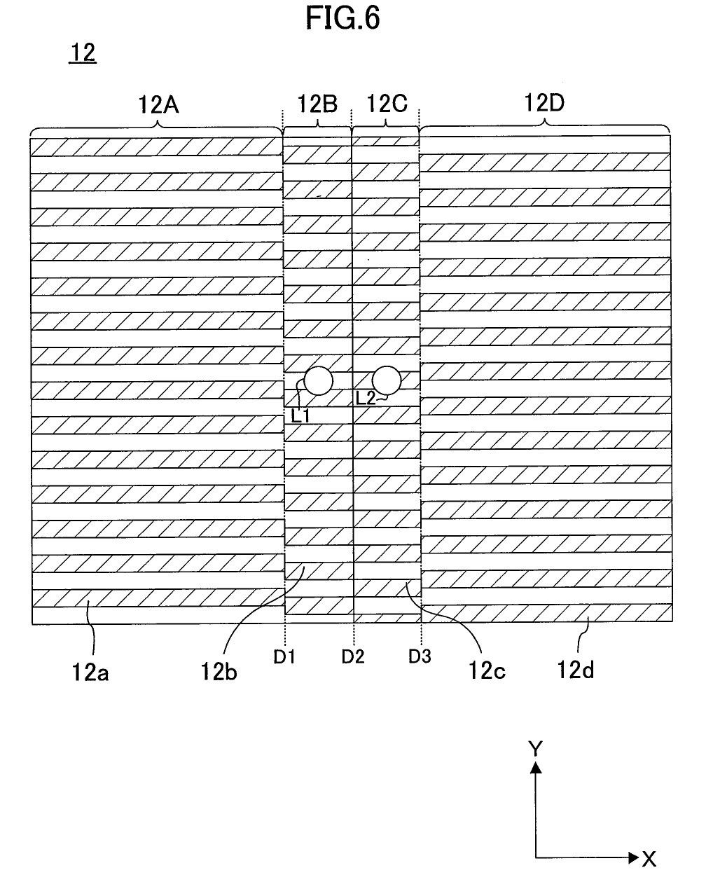

The foregoing description has been given on the case of the light beam 31. In the case of the light beam 32, the same advantages are obtained, except for a deviation of a center (emission center) L2 from the division line D2 as shown in FIG. 3. Whether the center L1 is placed on the division line D2 or the center L2 is placed on the division line D2 is determined depending on the tolerance of a system employing the optical pickup device. Thus, the center having a lower tolerance for the system is preferably placed on the division line D2. Alternatively, the centers L1 and L2 may be placed with the division line D2 sandwiched therebetween as shown in FIG. 6.

The optical information recording medium 51 is not specifically limited and may be a DVD-ROM, a DVD-RAM, a DVD-R, a DVD-RW, or a CD such as a CD-ROM, a CD-R, or a CD-RW. The wavelength λ1 of the light beam 31 and the wavelength λ2 of the light beam 32 are determined depending on the type of the optical information recording medium 51. Specifically, these wavelengths are approximately 650 nm for a DVD, and approximately about 780 nm for a CD. In the case of DVDs, stable tracking error signal detection is achieved for both a DVD such as a DVD-R having a guide groove pitch of 0.74 μm and a DVD such as a DVD-RAM having a guide groove pitch of 1.23 μm.

In this embodiment, the diffraction grating 12 is placed between the light source 11 and the half mirror 15 in the optical system illustrated in FIG. 1. Alternatively, the diffraction grating 12 may be placed between the half mirror 15 and the collimating lens 18, for example. In stead of the optical system illustrated in FIG. 1, an optical system in which a light source and a photodetector are integrated (e.g., an optical system using no half mirrors) may be employed so that a diffraction grating is placed between the light source and a collimating lens.

In this embodiment, the grating grooves in each region of the diffraction grating 12 are formed along the X direction, which is the radial direction of the optical information recording medium. Alternatively, the grating grooves may be formed along a slanting direction with respect to the X direction. In the foregoing example, the second region 12B and the third region 12C of the diffraction grating 12 have the same width. Alternatively, these regions may have different widths.

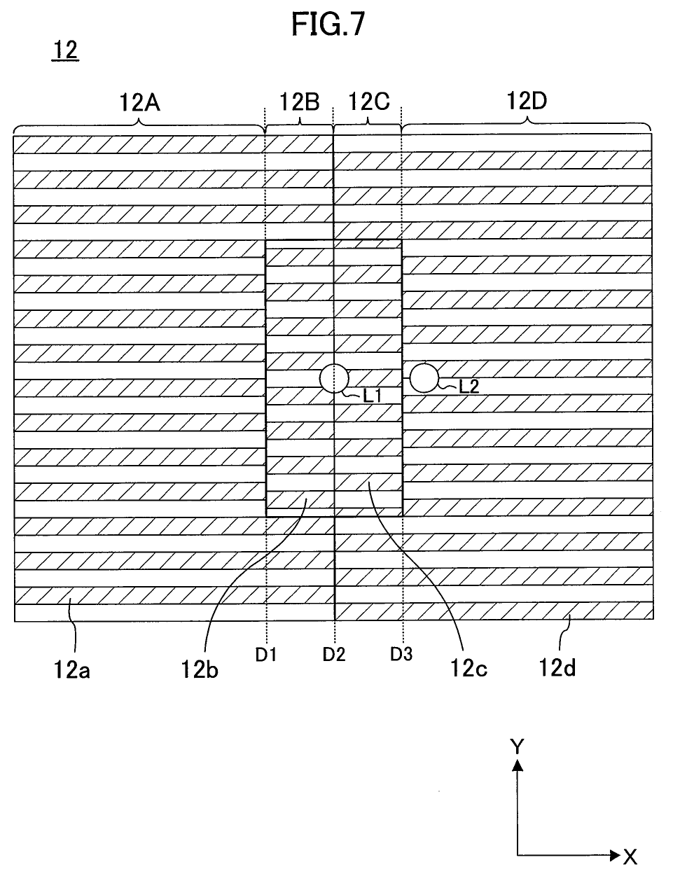

In this embodiment, the whole diffraction grating 12 is divided into the first region 12A, the second region 12B, the third region 12C, and the fourth region 12D. However, it is sufficient that only an area of the diffraction grating 12 within an effective beam diameter determined depending on the aperture diameter of the objective lens is divided into the first through fourth regions. The other area may be divided in another way. For example, as shown in FIG. 7, in the area outside the range of the effective beam diameter, the second region 12B and the third region 12C do not need to be formed.

In the case of using a light source for a DVD, the present invention is effective when the total width W1+W2 of the width W1 of the second region 12B and the width W2 of the third region 12C in the diffraction grating 12 is within the range from 10% to 40% of an effective beam diameter determined depending on the aperture diameter of the objective lens 19. In the case of using two light sources for a DVD and a CD, the present invention is effective when the total width W1+W2 of the width W1 of the second region 12B and the width W2 of the third region 12C in the diffraction grating 12 is within the range from 10% to 35% of the effective beam diameter determined depending on the aperture diameter of the objective lens 19.

In this embodiment, the phase differences between the first region 12A and the second region 12B and between the fourth region 12D and the third region 12C are both 90°. However, it is sufficient that the phase of the periodic structure in the first region 12A is substantially 180° different from that in the fourth region 12D and the phase of the periodic structure in the second region 12B is substantially 180° different from that in the third region 12C. The phase differences between the first region 12A and the second region 12B and between the fourth region 12D and the third region 12C are both in the range from 10° to 370°, and preferably in the range from 70° to 290°.

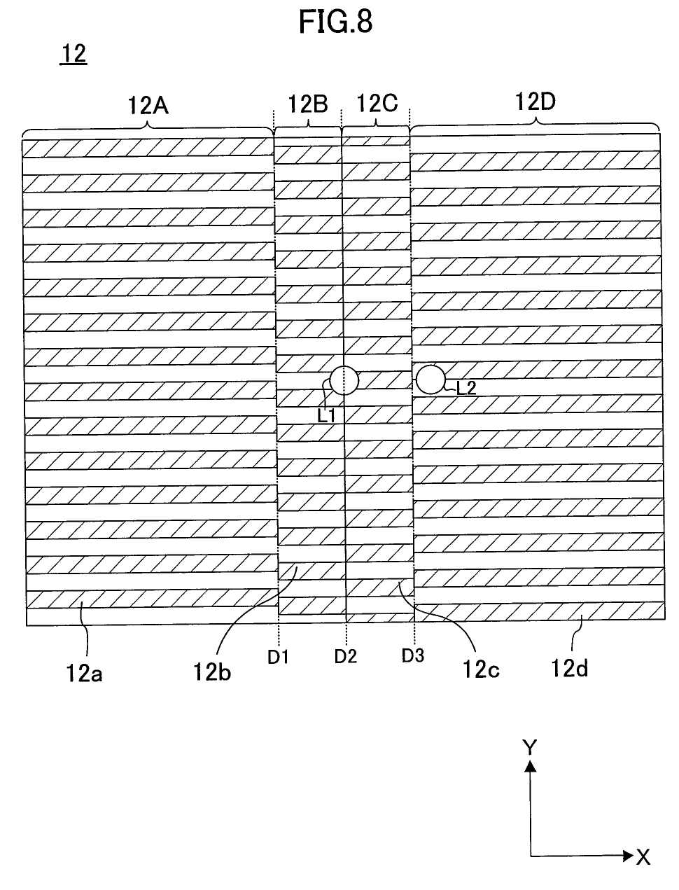

FIG. 8 illustrates a configuration in which the phase of the periodic structure in the first region 12A is substantially 1800 different from that in the fourth region 12D, the phase of the periodic structure in the second region 12B is substantially 180° different from that in the third region 12C, and the phase differences between the first region 12A and the second region 12B and between the fourth region 12D and the third region 12C are both 45°.

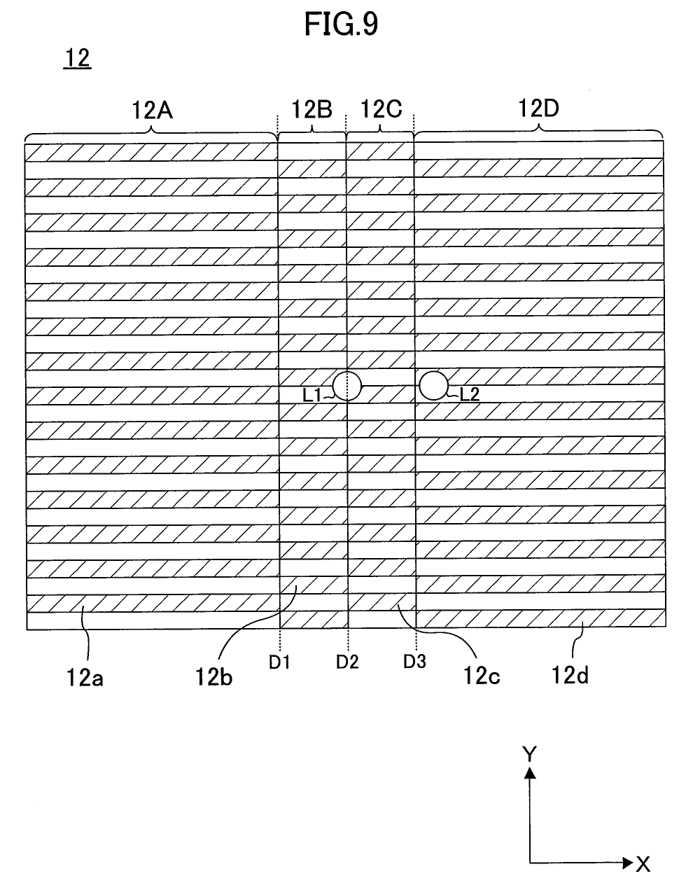

FIG. 9 illustrates a configuration in which the phase of the periodic structure in the first region 12A is substantially 180° different from that in the fourth region 12D, the phase of the periodic structure in the second region 12B is substantially 180° different from that in the third region 12C, and the phase differences between the first region 12A and the second region 12B and between the fourth region 12D and the third region 12C are both 180°.

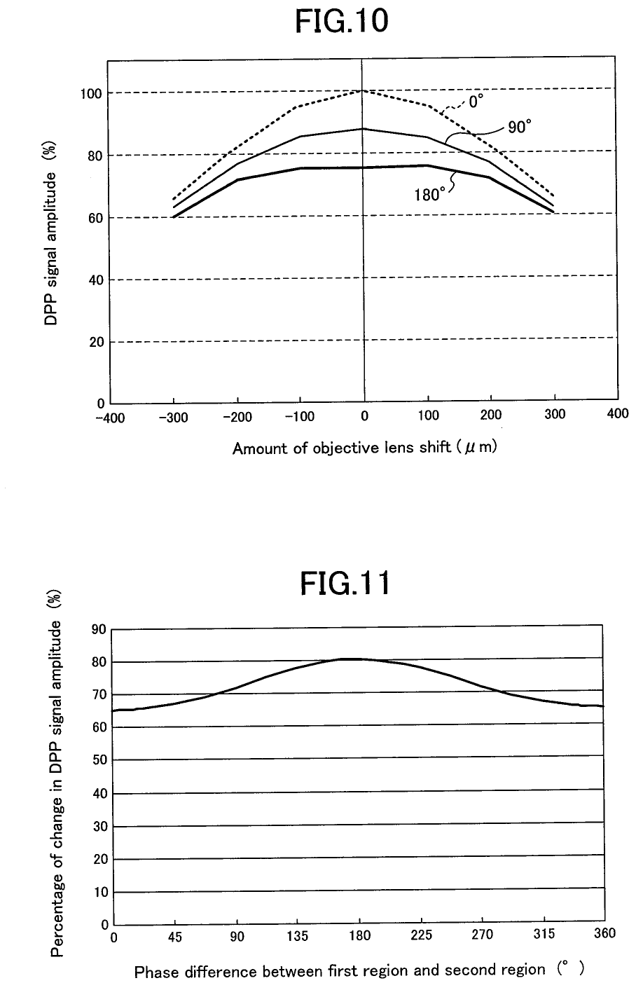

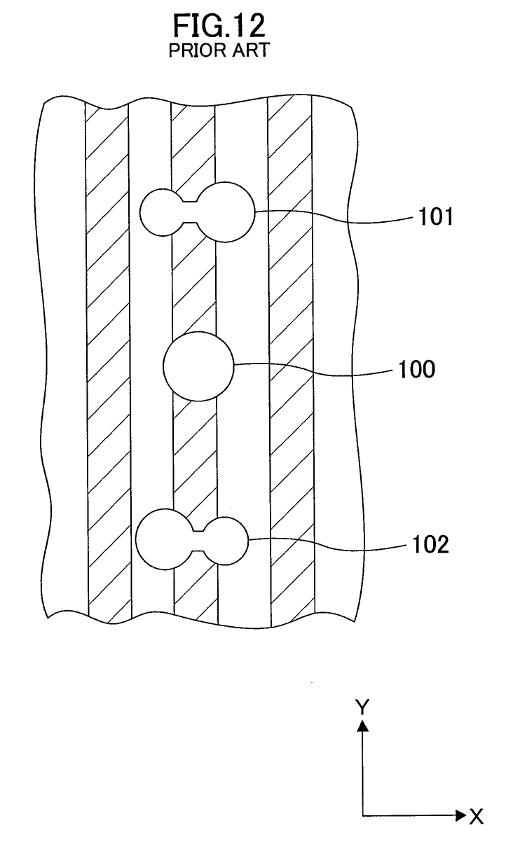

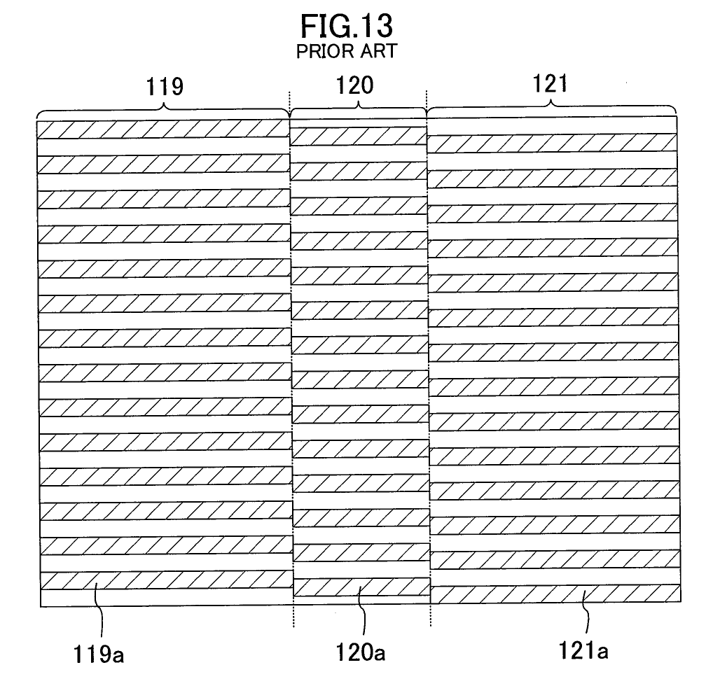

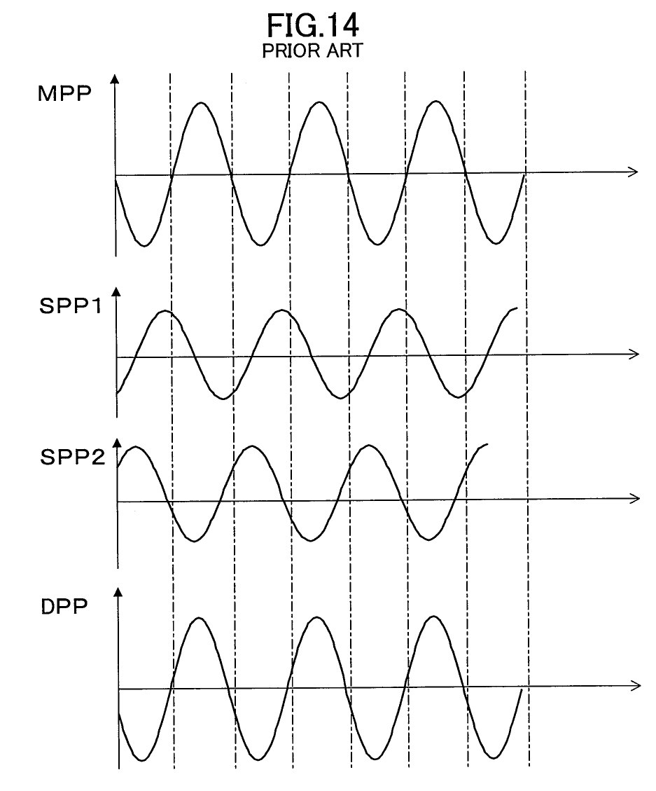

FIG. 10 shows a relationship between the amount of shift of the objective lens 19 and DPP signal amplitude in the case of using a DVD-RAM as the optical information recording medium 51. In the graph, the cases where the phase differences between the first region 12A and the second region 12B are 0°, 90°, and 180°, respectively, are shown. In FIG. 10, the ordinate indicates DPP signal amplitude where the DPP signal amplitude is 100% when the shift amount of the objective lens 19 is 0 μm. The phase of the periodic structure in the first region 12A is substantially 180° different from that in the fourth region 12D, and the phase of the periodic structure in the second region 12B is substantially 180° different from that in the third region 12C.

As shown in FIG. 10, the DPP signal amplitude with a shift of the objective lens greatly changes in the case of 0°, as compared to the case where the phase difference in periodic structure between the first region 12A and the second region 12B is 180°.

FIG. 11 shows a relationship between the percentage of change in DPP signal amplitude and the amount of phase difference between the first region 12A and the second region 12B. In FIG. 11, the percentage of change in DPP signal amplitude is indicated as a percentage of DPP signal amplitude when the shift amount of the objective lens is 300 μm with respect to the DPP signal amplitude when the shift amount of the objective lens is 0 μm.

As shown in FIG. 11, the percentage of change in DPP signal amplitude is closest to 100% when the phase difference in periodic structure between the first region 12A and the second region 12B is 180°, and decreases as the phase difference approaches 0° or 360°.

In the optical pickup device, since DPP signal amplitude is preferably constant even when the objective lens shifts, the percentage of change in DPP signal amplitude is preferably as close to 100% as possible. In view of this, it is sufficient that the phase difference in periodic structure between the first region 12A and the second region 12B is in the range from 10° to 350°, both inclusive. However, to make the DPP signal amplitude more constant, the phase difference is preferably in the range from 70° to 290°, both inclusive.

As described above, the optical pickup device of this embodiment is allowed to be used for optical information recording media with different guide groove pitches without a complicated optical system even for an optical pickup with two-wavelength light sources. Thus, tracking error signal detection for implementing more stable recording and reproducing is achieved. That is, the optical pickup device of this embodiment achieves size reduction, simplification, cost reduction, increase in efficiency, and other advantages of apparatus for recording and reproducing information on DVDs and CDs. In addition, the optical pickup device of this embodiment is very useful as an optical pickup device having the function of detecting a reproducing signal, a recording signal, and various servo signals for use in an optical head device which is a main part of an optical information processor for performing processing such as recording, reproducing and erasing of information on an optical information recording medium such as an optical disk.

As described above, according to the present invention, it is possible to implement an optical pickup device for performing stable tracking error detection on a plurality of optical information recording media with different guide groove pitches, while maintaining advantages of an in-line DPP method. The inventive optical pickup device is useful as, for example, an optical pickup device for use in an optical information processor for performing processing such as recording information on information recording media and reproducing or erasing of information on optical information recording media.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

What is claimed is:

1. An optical pickup device for recording information on an optical information recording medium and for reading and erasing information recorded on the optical information recording medium, the optical pickup device comprising:
a first light source for emitting a first light beam with a wavelength of λ1;
a second light source for emitting a second light beam with a wavelength of λ2;
a diffraction grating for separating each of the first light beam and the second light beam into at least a main beam and two sub-beams; and
a photodetector for receiving the first and second light beams reflected off a recording face of an optical information recording medium,
wherein the diffraction grating is divided into first, second, third, and fourth regions having periodic structures with different phases by division lines extending in parallel with a tangential direction of a track on the optical information recording medium,
the second region and the third region are located between the first region and the fourth region in such a manner that the second region is closer to the first region,
the periodic structure in the first region has a phase different from that in the second region,
the periodic structure in the second region has a phase substantially 180° different from that in the third region, and
the periodic structure in the first region has a phase substantially 180° different from that in the fourth region,
the photodetector includes:
a first light-receiving element group for receiving the first light beam; and
a second light-receiving element group for receiving the second light beam,
the first light-receiving element group includes:
a first light-receiving element for receiving the main beam obtained from the first light beam by the diffraction grating;
a second light-receiving element for receiving one of the two sub-beams obtained from the first light beam by the diffraction grating; and
a third light-receiving element for receiving the other sub-beam obtained from the first light beam by the diffraction grating,
the second light-receiving element group includes:
a fourth light-receiving element for receiving the main beam obtained from the second light beam by the diffraction grating;
a fifth light-receiving element for receiving one of the two sub-beams obtained from the second light beam by the diffraction grating; and
a sixth light-receiving element for receiving the other sub-beam obtained from the second light beam by the diffraction grating,
each of the first through sixth light-receiving elements is divided into at least two light-receiving regions by a division line extending along a tangential direction of the optical information recording medium,
the first, second, and third light-receiving elements are located on a first line with the first light-receiving element sandwiched between the second and third light-receiving elements,
the fourth, fifth, and sixth light-receiving elements are located on a second line with the fourth light-receiving element sandwiched between the fifth and sixth light-receiving elements, and
the first line and the second line are parallel to each other.

2. The optical pickup device of claim 1, wherein the distance between the division line dividing the first and second regions and the division line dividing the second and third regions is equal to the distance between the division line dividing the second and third regions and the division line dividing the third and fourth regions.

3. The optical pickup device of claim 1, wherein each of the first and second light beams includes a 0th order diffracted beam, a +1st order diffracted beam, and a −1st order diffracted beam.

4. The optical pickup device of claim 1, wherein a plurality of guide grooves are periodically arranged on the recording face of the optical information recording medium, and
each of the first and second light beams converges on one of the guide grooves.

5. The optical pickup device of claim 1, further comprising an arithmetic processing circuit for detecting a tracking error signal with a differential push-pull method, based on an output signal from the photodetector.

6. The optical pickup device of claim 1, wherein the phase of the periodic structure in the first region of the diffraction grating is different in the range from 10° to 350° from that in the second region of the diffraction grating.

7. The optical pickup device of claim 1, further comprising an objective lens for irradiating the recording face of the optical information recording medium with the first and second light beams as convergence spots,
wherein the total width of the width of the second region and the width of the third region in the diffraction grating is within the range from 10% to 40% of an effective beam diameter determined depending on an aperture diameter of the objective lens.

8. The optical pickup device of claim 1, wherein the distance between the first and second light-receiving elements and the distance between the first and third light-receiving elements are d1,
the distance between the fourth and fifth light-receiving elements and the distance between the fourth and fifth light-receiving elements are d2, and
the distances d1 and d2 and the wavelengths λ1 and λ2 have the following relationship:
d1/d2=λ1/λ2.

9. A photodetector, comprising:
a first light-receiving element group for receiving a first light beam; and
a second light-receiving element group for receiving a second light beam,
wherein the first light-receiving element group includes:
a first light-receiving element for receiving a main beam obtained from the first light beam by a diffraction grating;
a second light-receiving element for receiving a sub-beam obtained from the first light beam by the diffraction grating; and
a third light-receiving element for receiving another sub-beam obtained from the first light beam by the diffraction grating,
the second light-receiving element group includes:
a fourth light-receiving element for receiving a main beam obtained from the second light beam by the diffraction grating;
a fifth light-receiving element for receiving a sub-beam obtained from the second light beam by the diffraction grating; and
a sixth light-receiving element for receiving another sub-beam obtained from the second light beam by the diffraction grating,
each of the first through sixth light-receiving elements is divided into at least two light-receiving regions by a division line extending along a tangential direction of an optical information recording medium,
the first, second, and third light-receiving elements are located on a first line with the first light-receiving element sandwiched between the second and third light-receiving elements,
the fourth, fifth, and sixth light-receiving elements are located on a second line with the fourth light-receiving element sandwiched between the fifth and sixth light-receiving elements,
the first line and the second line are parallel to each other,
the diffraction grating separates each of the first light beam and the second light beam into at least the main beam and the two sub-beams and is divided into first, second, third, and fourth regions having periodic structures with different phases by division lines extending in parallel with a tangential direction of a track on the optical information recording medium,
the second region and the third region are located between the first region and the fourth region in such a manner that the second region is closer to the first region,
the periodic structure in the first region has a phase different from that in the second region,
the periodic structure in the second region has a phase substantially 180° different from that in the third region, and
the periodic structure in the first region has a phase substantially 180° different from that in the fourth region.

10. The photodetector of claim 9, wherein the distance between the division line dividing the first and second regions and the division line dividing the second and third regions is equal to the distance between the division line dividing the second and third regions and the division line dividing the third and fourth regions.

11. The photodetector of claim 9, wherein each of the first and second light beams includes a 0th order diffracted beam, a +1st order diffracted beam, and a −1st order diffracted beam.

12. The photodetector of claim 9, wherein a plurality of guide grooves are periodically arranged on a recording face of the optical information recording medium, and
each of the first and second light beams converges on one of the guide grooves.

13. The photodetector of claim 9, further comprising an arithmetic processing circuit for detecting a tracking error signal with a differential push-pull method, based on output signals from the first light-receiving element group and the second light-receiving element group.

14. The photodetector of claim 9, wherein the phase of the periodic structure in the first region of the diffraction grating is different in the range from 10° to 350° from that in the second region of the diffraction grating.

15. The photodetector of claim 9, wherein the total width of the width of the second region and the width of the third region in the diffraction grating is within the range from 10% to 40% of an effective beam diameter determined depending on an aperture diameter of an objective lens for irradiating a recording face of the optical information recording medium with the first and second light beams.

16. The photodetector of claim 9, wherein the distance between the first and second light-receiving elements and the distance between the first and third light-receiving elements are d1,
the distance between the fourth and fifth light-receiving elements and the distance between the fourth and fifth light-receiving elements are d2,
the wavelength of the first light beam is λ1,
the wavelength of the second light beam is λ2, and
the distances d1 and d2 and the wavelengths λ1 and λ2 have the following relationship:
d1/d2=λ1/λ2.
